(19) United States
(12) Patent Application Publication
(10) Pub. No.: US 2015/0018074 A1
(43) Pub. Date: Jan. 15, 2015

(54) Mobile gaming application

(71) Applicant: Griffin Pierce, Chula Vista, CA (US)

(72) Inventor: Griffin Pierce, Chula Vista, CA (US)

(21) Appl. No.: 13/987,194

(22) Filed: Jul. 11, 2013

(51) Int. Cl. G07F 17/32

(52) U.S. Cl. CPC G07F 17/3244; G07F 17/3225
USPC 463/25

(57) ABSTRACT

The mobile gaming application is a specific process by which a person may download a free or paid version of the application from the internet and is able to search for live play at physical casinos or search for online casinos and various card games being played at that time and in the near future. By searching by state, county, and city and even zip code the person searching will find casino card games of their choice by using their cell phone, lap top, or computer and being able to reserve a seat at that table for live or online games and be able buy in to those games mobile using GPS and through existing casino software or by using specific software offered the mobile application itself. The application maintains a permanent record of wins and losses over short or long periods of time and allows sharing on social media for friends and fellow players to be a competition for a more effective function of the application. The application may link to existing casino software or is used for free search without the linking process.

### BACKGROUND OF THE INVENTION

(1) Field of the Invention

The “Mobile Gaming Application” is in the legal gambling field working with physical casinos and online casinos using a mobile application for cell phones, laptops and such that provides free search capability and linking to casino software.

(2) Description of the art including information disclosed under 37 CFR 1.97 & 1.98

The art described in the drawings of the utility function illustrate the unique ability of the mobile gaming application and there is no prior art discovered through a patent search that we could find.

### BRIEF SUMMARY OF THE INVENTION

The Mobile Gaming Application is a new process and software application for poker players seeking a physical location that allows the player to find out if there are seats available at that casino location or if there are seats available with an online casino as well. It also allows the buy-in using a debit pr credit card to enter into the game whether live or online. There is a free version of the application and a paid version of the application as defined further in the specifications. The process is the main focus in this patent application and the software portion will be the main focus in a future patent application.

### BRIEF DESCRIPTION OF THE SEVERAL VIEWS OF THE DRAWINGS

There are 18 drawings in total that describe and illustrate the process and function of the “Mobile Gaming Application”. The Figures will be described in detail within the preferred embodiment and the detailed description.

### DETAILED DESCRIPTION OF THE PREFFERED EMBODIMENT

FIG. 14: Screen 14

This screen will be the first screen that you see when the mobile application is opened. This screen will let the user choose online play or live (in person) play. After choosing one of the 2 options they will be moved to screen 1 or 15. If live screen 1 if online screen 15.

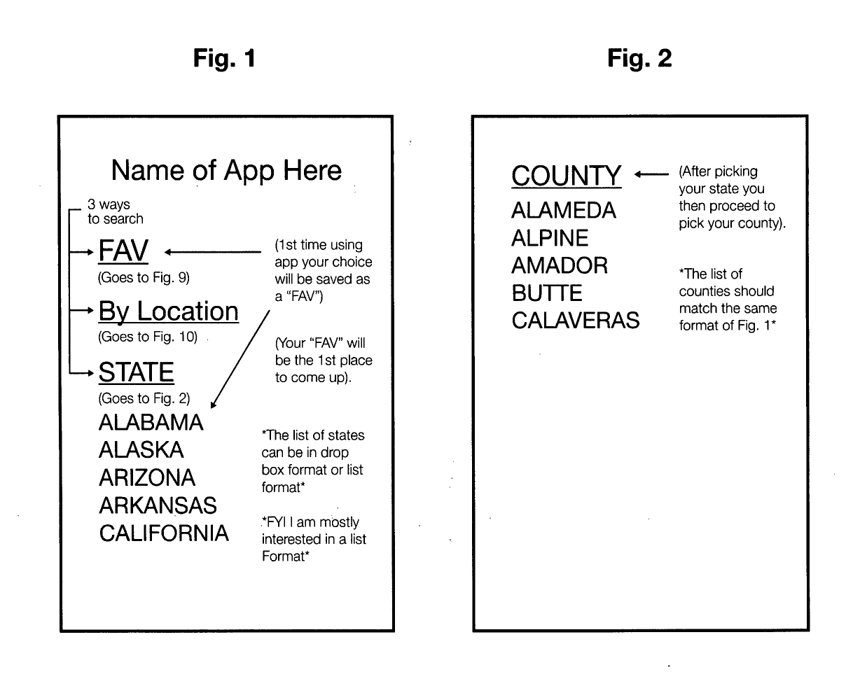

FIG. 1: Screen 1

This will be the main screen used for live play. This screen will give you three options to search for a card room; by favorites which will be added when you like a casino and tell it to go in your favorites, by location base on your GPS on your phone, and by State. If you are choosing by state it will have a drop down list of every state. After you click the option you want you are moved to the screen as followed. Fav screen 9, location screen 10, and state screen 2.

FIG. 2: Screen 2

This screen will let you choose the county of the state where you would like to find the casino and card room in the county you chose on screen 1.

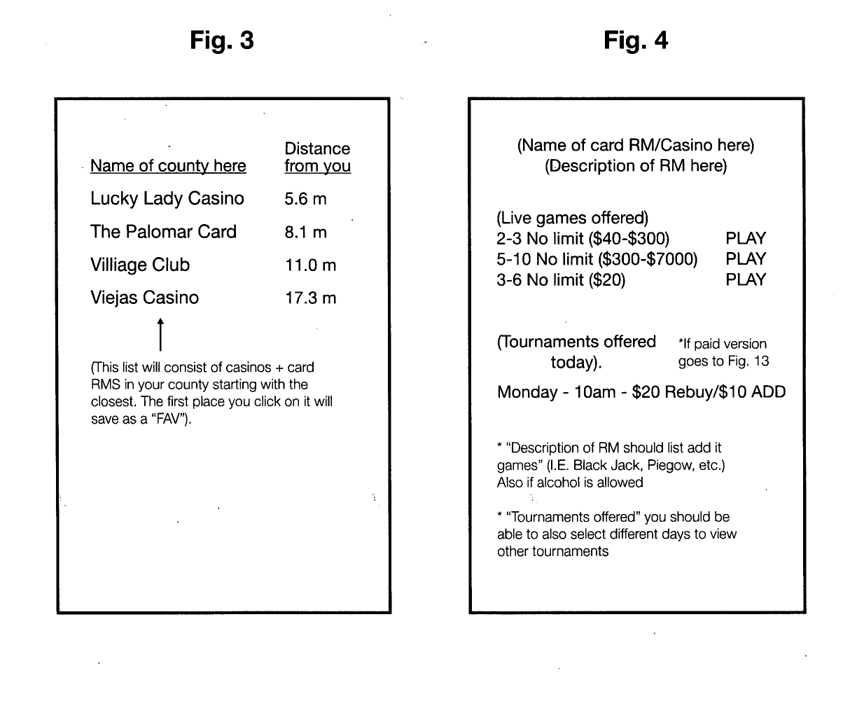

FIG. 3: Screen 3

This screen has all the card rooms that are in the county that you have chosen and will have the list in order from closest to furthest away from you. You will then pick the card room you would like to view from this screen. You will then go to screen 4

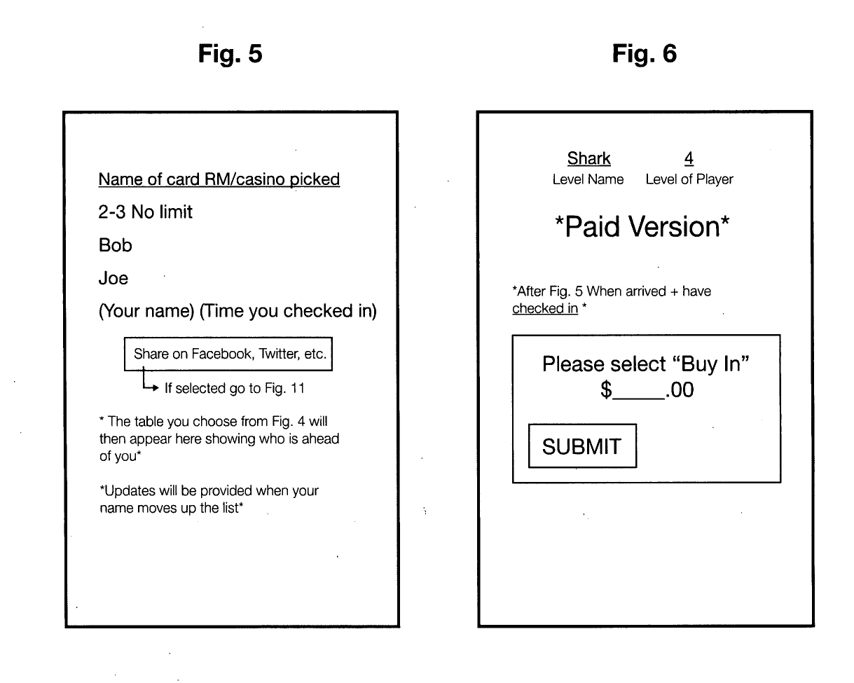

FIG. 4: Screen 4

This screen is the home screen for all the card rooms based on their pick from screen 3 and the casino card rooms name will be on the top and will have the description below it telling the players what other games in play other than poker and if there is food and alcohol, and the hours they are open. Under all of this will be what live games they have to offer right now and the waiting list for all of them. If you would like to play one of the games they have, then you click the play button to the right of the name of the game and this will take you to screen 5. At that moment you name will be added to the casinos list via a server. On the bottom of this screen there are the Tournaments that are offered for the day and if they have the paid version then they can click tournaments and it will take them to screen 13.

FIG. 5: Screen 5

This will be the screen that you see when you have checked in and are on the waiting list in one of the card rooms. This screen will have the entire waiting list for the game and where you are on this list will be up to date from the list in the casino and will send and receive data to the casinos software via servers. It will show you what time you checked in and will move you up the list as people get seats. Also from this list you can click the share button which will let you post to Facebook or twitter or other social media sites allowing your friends to see what you are doing and have the chance to join you. If share is selected screen 11 is what your friends will see.

FIG. 6: Screen 6

This screen will only be on the paid version. This screen will allow the user enter the amount of the buy in for the game chosen and being played. It will also have the level of the play and the name assigned to that level. All this is to add more fun and entertainment fun to show your friends giveaways and what is happening at some point. Level will be based off of how many hours you are clocked in the game and how much you win in tournaments. If the player does use screen 5 after they submit the amount of the buy in they sat down with then screen 7 will be displayed.

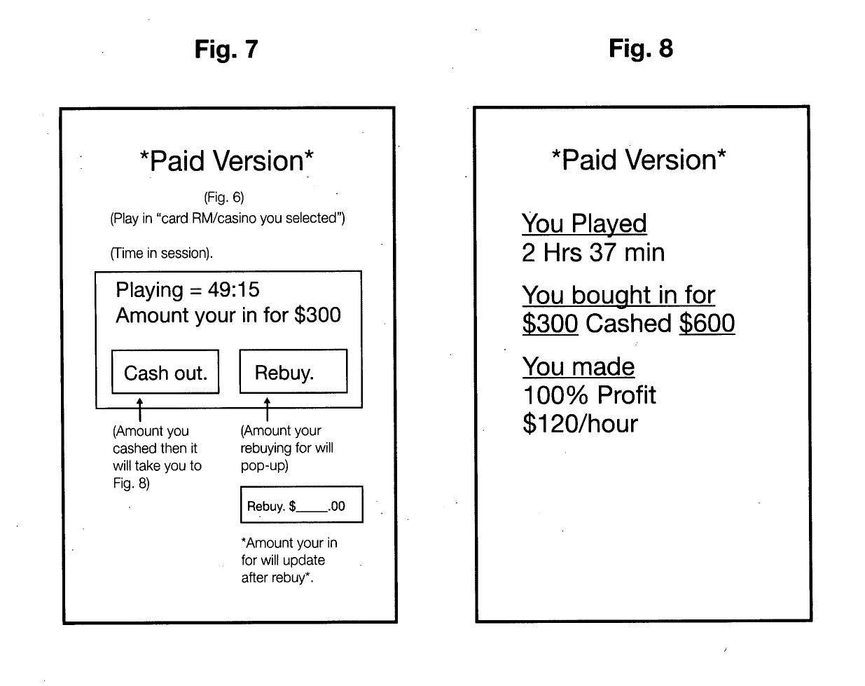

FIG. 7: Screen 7

This screen will be up the entire time you are sitting at the table. It will show how long you have been playing and how much money you are in for and it will also allow you to rebuy if you need more money for more play or will cash you out when you leave. If you click the rebuy a pop up will display asking how much you wish to rebuy for and if you cash out it will take you to screen 8.

FIG. 8: Screen 8

This screen will show all the data from your session. You will see how many hours you played, how much you bought in for and how much you cashed out and how much you made for the day and per hour. It will also have 2 buttons on the bottom Win/loss and Graph and if you click one of these you will go to screen 16 or 17 and it will show the graphs or wins and loss that you have had in the last day, week, month, year, or your life.

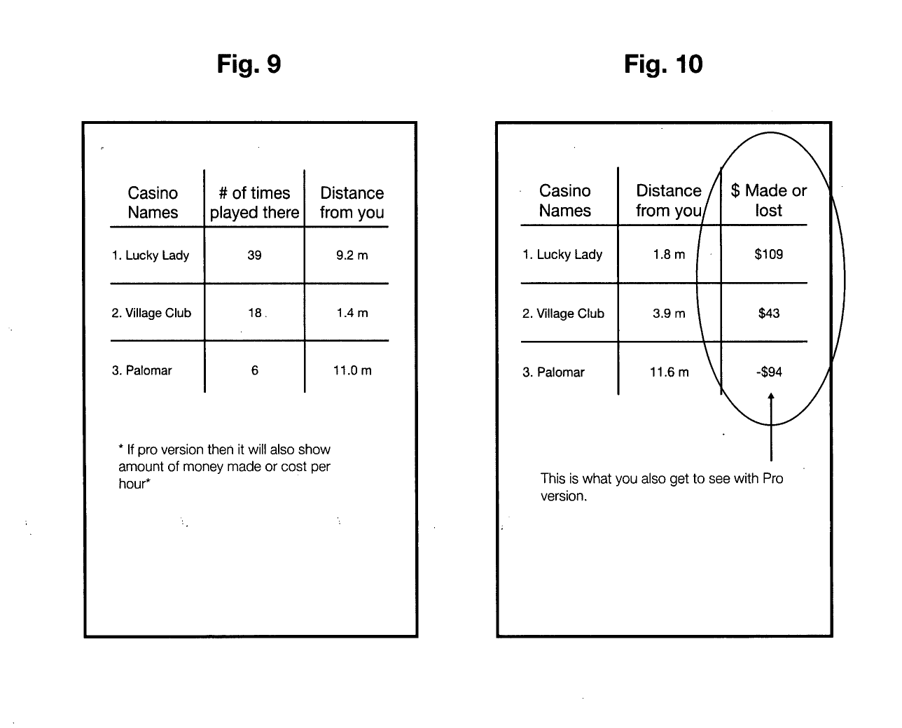

FIG. 9: Screen 9

This screen is just one of the ways you could have asked to search for a card room. This screen will only show the card rooms that you have told the app to add to your favorites. The list will be set up with the most played at the casino card room on top and it will also show how far it is from you. If you have the paid version there is be an added column that will show the amount you have won or lost in that card room. This screen acts just like screen 3 and after the card room is selected you will go to screen 4.

FIG. 10: Screen 10

This screen is just one of the ways you could have asked to search for a card room. This screen will show all card rooms in your area starting with the closest. If you have the paid version you will also have the win or loss column. This screen acts just like screen 3 and after the card room is selected you will go to screen 4.

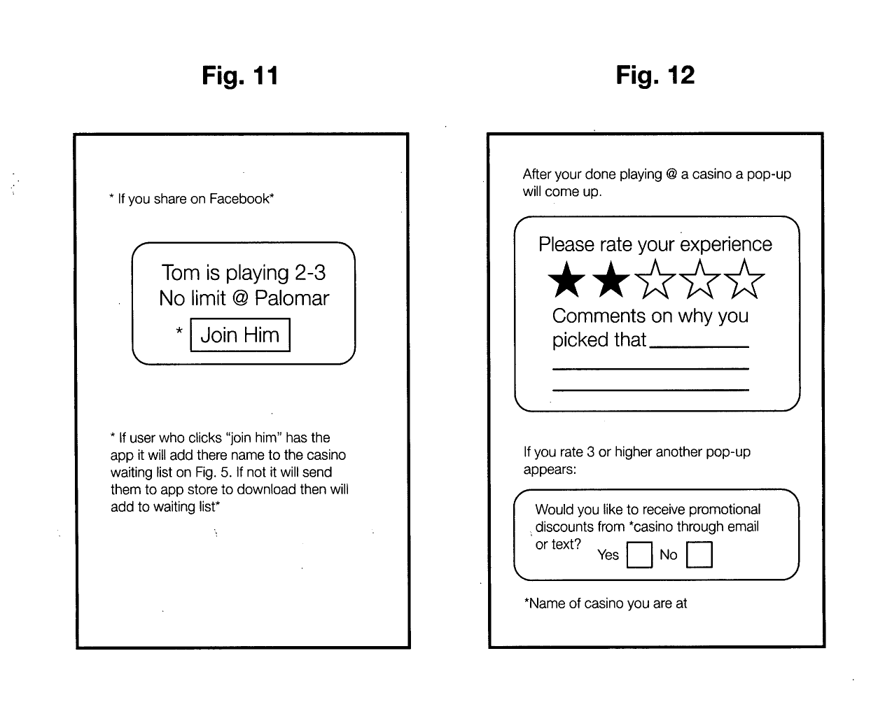

FIG. 11: Screen 11

This screen is just showing what it will look like on Facebook if you click share on screen 5. If the person on Facebook clicks join them they will be added to the waiting list at the same card room and limit you are playing; if they do not have the app it will send them to the store to download it.

FIG. 12: Screen 12

This screen is what will pop up after you are done playing. It will let know you're done by your GPS leaving the area or that you have cashed out. This pop up will let you give feedback quickly and rate the card room helping users find better card rooms and giving card rooms good feedback. If you rated 3 or higher one more pop up will ask if you would like to receive promotions from the card room via email or text.

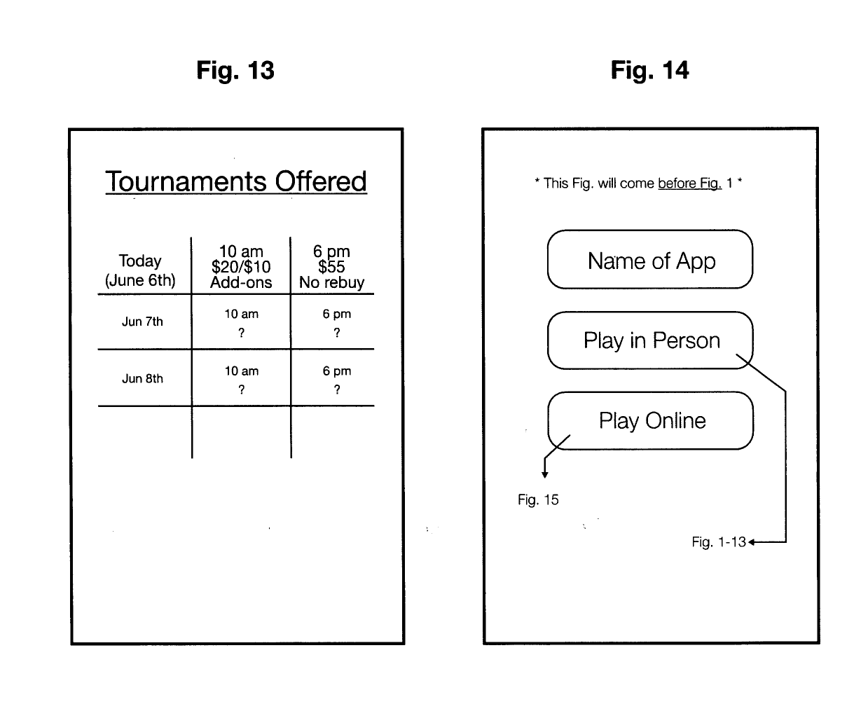

FIG. 13: Screen 13

This screen is the screen that if the person has the paid version will show the tournaments offered by that card room. It will show the dates and what tournaments are offered for that week as well as a link to download the whole month. It will allow them to click on the tournament they want to learn more about. After they click the tournament they want to know more about it takes them to screen 18.

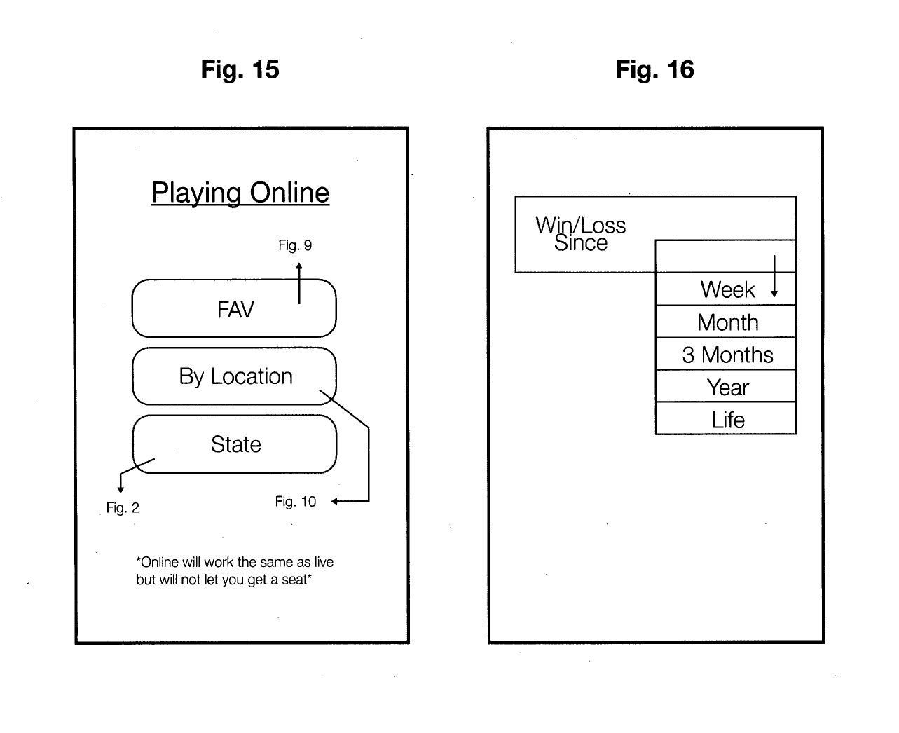

FIG. 15: Screen 15

This screen is for online casinos and will look and act just like screen 1 for live play. It will also send them to the next screen 9, 10, or 2. With the online play it will only take you to the list of online card rooms and it will look like screen 3.

FIG. 16: Screen 16

This screen displays your wins and losses over different periods of time from a week to a month to 3 months to a year and for life for the live and online poker playing.

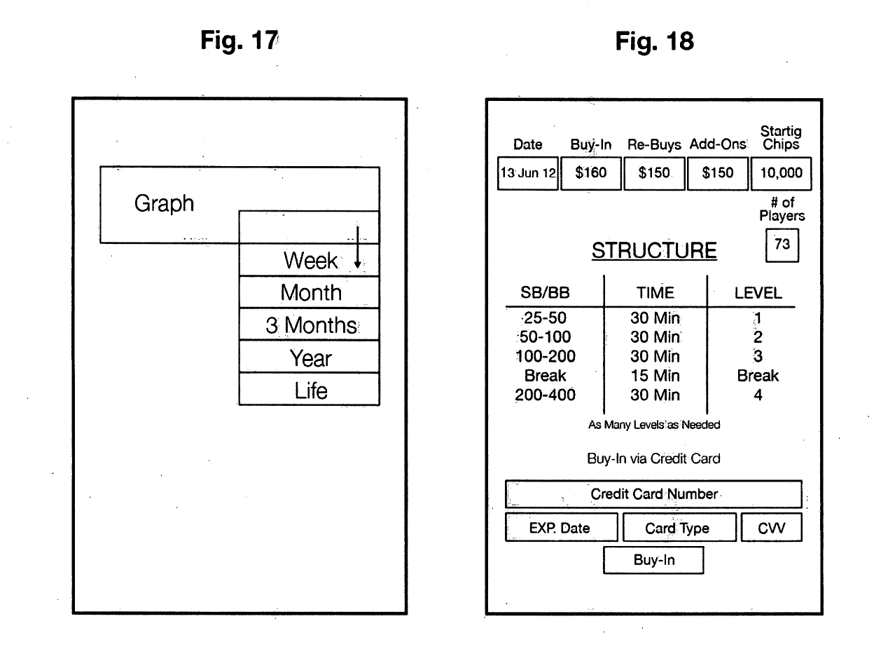

FIG. 17: Screen 17

This screen displays your wins and losses over different periods of time from a week to a month to 3 months to a year to and for life for the live and online poker playing and displays a graph to show the results from each live or online casino in much more detail.

FIG. 18: Screen 18

This screen will show all the details for the tournament and it will show the buy in, the rebuy, and add on if there is one, and it will show the starting chips and the structure. It will let them buy in to the tournament using a credit card.

### DETAILED DESCRIPTION OF THE INVENTION

In this section the detailed description is exactly like the preferred embodiment because it is an exact description of how the process functions. There is no difference between the two sections of this specification.

FIG. 14: Screen 14

This screen will be the first screen that you see when the mobile application is opened. This screen will let the user choose online play or live (in person) play. After choosing one of the 2 options they will be moved to screen 1 or 15. If live screen 1 if online screen 15.

FIG. 1: Screen 1

This will be the main screen used for live play. This screen will give you three options to search for a card room; by favorites which will be added when you like a casino and tell it to go in your favorites, by location base on your GPS on your phone, and by State. If you are choosing by state it will have a drop down list of every state. After you click the option you want you are moved to the screen as followed. Fav screen 9, location screen 10, and state screen 2.

FIG. 2: Screen 2

This screen will let you choose the county of the state where you would like to find the casino and card room in the county you chose on screen 1.

FIG. 3: Screen 3

This screen has all the card rooms that are in the county that you have chosen and will have the list in order from closest to furthest away from you. You will then pick the card room you would like to view from this screen. You will then go to screen 4

FIG. 4: Screen 4

This screen is the home screen for all the card rooms based on their pick from screen 3 and the casino card rooms name will be on the top and will have the description below it telling the players what other games in play other than poker and if there is food and alcohol, and the hours they are open. Under all of this will be what live games they have to offer right now and the waiting list for all of them. If you would like to play one of the games they have, then you click the play button to the right of the name of the game and this will take you to screen 5. At that moment you name will be added to the casinos list via a server. On the bottom of this screen there are the Tournaments that are offered for the day and if they have the paid version then they can click tournaments and it will take them to screen 13.

FIG. 5: Screen 5

This will be the screen that you see when you have checked in and are on the waiting list in one of the card rooms. This screen will have the entire waiting list for the game and where you are on this list will be up to date from the list in the casino and will send and receive data to the casinos software via servers. It will show you what time you checked in and will move you up the list as people get seats. Also from this list you can click the share button which will let you post to Facebook or twitter or other social media sites allowing your friends to see what you are doing and have the chance to join you. If share is selected screen 11 is what your friends will see.

FIG. 6: Screen 6

This screen will only be on the paid version. This screen will allow the user enter the amount of the buy in for the game chosen and being played. It will also have the level of the play and the name assigned to that level. All this is to add more fun and entertainment fun to show your friends giveaways and what is happening at some point. Level will be based off of how many hours you are clocked in the game and how much you win in tournaments. If the player does use screen 5 after they submit the amount of the buy in they sat down with then screen 7 will be displayed.

FIG. 7: Screen 7

This screen will be up the entire time you are sitting at the table. It will show how long you have been playing and how much money you are in for and it will also allow you to rebuy if you need more money for more play or will cash you out when you leave. If you click the rebuy a pop up will display asking how much you wish to rebuy for and if you cash out it will take you to screen 8.

FIG. 8: Screen 8

This screen will show all the data from your session. You will see how many hours you played, how much you bought in for and how much you cashed out and how much you made for the day and per hour. It will also have 2 buttons on the bottom Win/loss and Graph and if you click one of these you will go to screen 16 or 17 and it will show the graphs or wins and loss that you have had in the last day, week, month, year, or your life.

FIG. 9: Screen 9

This screen is just one of the ways you could have asked to search for a card room. This screen will only show the card rooms that you have told the app to add to your favorites. The list will be set up with the most played at the casino card room on top and it will also show how far it is from you. If you have the paid version there is be an added column that will show the amount you have won or lost in that card room. This screen acts just like screen 3 and after the card room is selected you will go to screen 4.

FIG. 10: Screen 10

This screen is just one of the ways you could have asked to search for a card room. This screen will show all card rooms in your area starting with the closest. If you have the paid version you will also have the win or loss column. This screen acts just like screen 3 and after the card room is selected you will go to screen 4.

FIG. 11: Screen 11

This screen is just showing what it will look like on Facebook if you click share on screen 5. If the person on Facebook clicks join them they will be added to the waiting list at the same card room and limit you are playing; if they do not have the app it will send them to the store to download it.

FIG. 12: Screen 12

This screen is what will pop up after you are done playing. It will let know you're done by your GPS leaving the area or that you have cashed out. This pop up will let you give feedback quickly and rate the card room helping users find better card rooms and giving card rooms good feedback. If you rated 3 or higher one more pop up will ask if you would like to receive promotions from the card room via email or text.

FIG. 13: Screen 13

This screen is the screen that if the person has the paid version will show the tournaments offered by that card room. It will show the dates and what tournaments are offered for that week as well as a link to download the whole month. It will allow them to click on the tournament they want to learn more about. After they click the tournament they want to know more about it takes them to screen 18.

FIG. 15: Screen 15

This screen is for online casinos and will look and act just like screen 1 for live play. It will also send them to the next screen 9, 10, or 2. With the online play it will only take you to the list of online card rooms and it will look like screen 3.

FIG. 16: Screen 16

This screen displays your wins and losses over different periods of time from a week to a month to 3 months to a year and for life for the live and online poker playing.

FIG. 17: Screen 17

This screen displays your wins and losses over different periods of time from a week to a month to 3 months to a year to and for life for the live and online poker playing and displays a graph to show the results from each live or online casino in much more detail.

FIG. 18: Screen 18

This screen is an example of what a person will see as all the details for the tournament and it will show the buy in, the rebuy, and add on if there is one, and it will show the starting chips and the structure. It will let them buy in to the tournament using a credit card.

What is claimed is:

1. A free and paid mobile gaming application that is downloadable from the internet and is used by a cell phone, laptop, or PC computer that links users to casino software and for free search and is comprised of multiple screens that function as:
A: To locate a physical location of a casino the first screen 14 allows the choice of live casino play or online casino play and for live play shall move to screen 1 which allows the option of choosing by the state where the casino is located and by choosing that state shall move to screen 2 which allows the choice of choosing the county where the casino is located and tells the user which is the closest and farthest from the user current location by GPS and then move to screen 3 finding the exact casino by search and therefore find the card room the user prefers and move to screen 4 which describes the card room capabilities as to buy in, food, alcohol, and allows the user to sign up for a waiting list for any specific game being played and the time that the seat will be open being connected to the casino software that is existing or by using software supplied by the application for the casino.
B: Once the game is chosen and the user is on the waiting list the user will move to screen 5 on the free version which allows the user to share this information with friends and other players that wish to join that game in progress and if the share feature is selected the user moves to screen 11 and shares that information with social media to invite other players to join the game and will allow other players to download the application from the internet for free.
C: Screen 6 is for the paid version which allows the player to enter in the buy in amount for the game by mobile and will display the level of play and will display the time checked in and hours of play and will move onto screen 7 displaying live time when the player has physically checked in or checked in online to the actual game being played and will also allow the player to rebuy for more chips or tokens for the game to continue in live time without leaving the table and to maintain accuracy of the money user has spent displayed on all screens.
D: Screen 8 is displayed when you check out or cash out of the game displaying the win and loss factor of your play which will allow the user to choose screen 16 or 17 for more detailed information as to the level of play that the player was to achieve during that period of time and having a history of play that is a permanent record kept by the application for future reference while screen 12 which allow the user to give positive or negative feedback regarding their experience at that casino and card room and by giving positive ratings of 3 and more will allow the user to receive promotions from the casino via email or text.

2. The application allows various search features once in the main player area as:
A: Screen 9 displays which casinos and card rooms the user has added to their favorites and will set up the list closest to furthest of the users physical location and for the paid version will allow the user to know how much was lost or won in each casino or card room while screen 10 which is also the paid version will show the details of past games played and won or lost and the amount of money bought and cashed out.
B: With the paid version screen 13 displays tournaments that are being offered by the casinos and card rooms and what dates and a link for the entire month if desired and choose a tournament of interest while moving to screen 18 which will display the details of the tournament such as rebuys, any add on, starting chips or tokens and the structure and will allow the user to pay by credit card to buy in to the tournament and display the amount of players that have bought in and request a specific seat number.

3. Screen 15 is for online use with the identical features of screen 1 and moves onto screens 9, 10, and 2 once selected.
